(19) United States
(12) Patent Application Publication
(10) Pub. No.: US 2005/0282090 A1
(43) Pub. Date: Dec. 22, 2005

(54) Composition for forming antireflection coating

(76) Inventors: Kawasaki-shi Hirayama, Kawasaki-shi (JP); Tomotaka Yamada, Kawasaki-shi (JP); Daisuke Kawana, Kawasaki-shi (JP); Kazufumi Sato, Kawasaki-shi (JP)

Correspondence Address: WENDEROTH, LIND & PONACK, L.L.P., 2033 K STREET N. W., SUITE 800, WASHINGTON, DC, 20006-1021, US

(21) Appl. No.: 10/537,152

(22) PCT Filed: Dec. 1, 2003
(86) PCT No.: PCT/JP03/15343

§ 371 Date: Jun. 24, 2005

(30) Foreign Application Priority Data
Dec. 2, 2002 (JP) 2002-382898
Apr. 21, 2003 (JP) 2003-116164

(51) Int. Cl. G03C 5/00

(52) U.S. Cl. 430/322

(57) ABSTRACT

A composition for forming an antireflection coating, characterized in that it comprises an organic solvent and, dissolved therein, (A) a ladder silicone copolymer containing (a₁) 10 to 90 mole % of a (hydroxyphenylalkyl)silses-quioxane unit, (a₂) 0 to 50 mole % of a (alkoxyphenylalkyl)silsesquioxane unit and (a₃) 10 to 90 mole % of an alkyl or phenylsilsesquioxane unit, (B) an acid generator generating an acid upon exposure to heat or light, and (C) a crosslinking agent, and is capable of forming an antireflection coating exhibiting an optional parameter (k value) for an ArF laser of the range of 0.002 to 0.95. The composition is soluble in an organic solvent, can be applied by a conventional spin coating method with ease, has good storage stability, and can exhibit an adjusted preventive capability for reflection through the introduction of a chromophoric group absorbing a radiation ray thereto.

### TECHNOLOGICAL FIELD

The present invention relates to a composition for formation of an antireflection film which is provided intermediately between a substrate and a resist film in a resist material used for the preparation of semiconductor devices in the lithographic process as well as a ladder-type silicone copolymer used therein.

### BACKGROUND TECHNOLOGY

Along with the progress in the semiconductor devices toward higher fineness in recent years, further increased fineness is required in the photolithographic process used in the manufacture thereof. While, in the manufacture of semiconductors in general, a resist pattern is formed by utilizing the lithographic technology on a substrate such as a silicon wafer, oxidized silicon film, interlayer insulation film and the like and, by using the same as a mask, the substrate is subjected to etching, it is required with respect to fineness of the resist to realize control of the line width of the resist pattern without affecting resolution of the fine pattern but still with high accuracy.

When an attempt is made to accomplish thus requirement, the reflection of the radiation taking place at the interface between the substrate and the resist film is now very significant in the light-exposure of the resist for pattern formation. Namely, in case where reflection of radiation takes place between the resist film and the substrate, an accurate pattern can no longer be obtained with varied line width of the resist pattern as a result of the variations of the radiation intensity within the resist.

In order to suppress such drawbacks, it is practiced to provide a coating film such as an antireflection film and a protecting film between the resist and the substrate but a drawback is caused in the transformation of the resist pattern due to the proximity of the etching rate of the material constituting these coating films to that of the resist and, in addition, troubles are caused in conducting removal of such a coating film due to film thickness reduction of the resist pattern and degradation of the profile leading to a defective decrease in the working precision of the substrate.

Although it is also practiced to have an increased film thickness of the resist film in order to ensure sufficiently high resistance against etching, defects are caused with a too large film thickness thereof due to pattern falling of a resist pattern or, especially, an isolated pattern, with a large aspect ratio between the line width of the resist pattern and the thickness of the resist film in the step of development and a decrease in the pattern resolution of the resist in the step of light-exposure.

Besides, a process of a three-layered resist is conducted by providing an intermediate layer between the resist film and the coating film or, namely, the organic layer as the underlying layer and this intermediate layer is required to have characteristics of being capable of forming thereon a resist pattern having good reproducibility with a good profile, having high resistance against plasma etching along with high plasma etching selectivity to the organic layer as the underlying layer, having resistance against an alkaline developer solution and the like so that several materials have been heretofore proposed in order to satisfy these requirements.

While, for example, proposals are made for providing an intermediate layer consisting of a hydrolysate and/or condensate of an inorganic or organic silane compound (see patent document 1), the conventional spin coating method cannot be employed in conducting film formation for this intermediate layer due to the use of a coating solution containing a silane compound but a coater truck for particular use must be employed and, in addition, a heat treatment at a high temperature of 300° C. or higher is required for the removal of the by-products produced in the course of the condensation reaction and the reflection-preventing power can hardly be imparted because chromophores against radiation cannot be introduced with stability as the defects thereof.

Also, a proposal is made (see patent document 2) for an organic reflection-preventing hard mask containing an inorganic element selected from the Groups of IIIa, IVa, Va, VIa, VIIIa, VIII, Ib, IIb, IIIb, IVb and Vb in the Periodic Table on a dielectric layer but this material is also defective that adjustment of the reflection-preventing power required case-by-case cannot be undertaken because the chromophores against radiation cannot be introduced with stability.

Patent Document 1
Official publication of Japanese Patent Kokai No. 2002-40668 (Claims and elsewhere)

Patent Document 2
Official publication of Japanese Patent Kokai No. 2001-53068 (Claims and elsewhere)

### DISCLOSURE OF THE INVENTION

The present invention has been completed with an object to provide a composition for formation of an antireflection film which is soluble in organic solvents and suitable for coating with easiness by a conventional spin-coating method, having high storage stability and which is suitable for adjustment of the reflection-preventing power by introducing chromophores capable of absorbing radiations as well as a ladder-type silicone copolymer used therein.

The inventors have continued extensive investigations with respect to an intermediate layer capable of exhibiting prevention of reflection with efficiency when formed between a resist film and a substrate or so-called hard mask materials for the three-layered resist process and, as a result, have arrived at a discovery that a composition containing a ladder-type silicone copolymer having a specified composition, an acid-generating agent and a crosslinking agent is soluble in organic solvents, can be easily applied by the conventional spin-coating method, is suitable for ready introduction of chromophores for absorption of radiations so as to form a stabilized antireflection film having an adequately adjusted reflection-preventing power leading to completion of the present invention on the base of this discovery.

Namely, the present invention provides a composition for formation of an antireflection film prepared by dissolving, in an organic solvent, (A) a ladder-type silicone copolymer consisting of (a₁) 10-90% by moles of (hydroxyphenylalkyl)silsesquioxane units, (a₂) 0-50% by moles of (alkoxyphenylalkyl)silsesquioxane units and (a₃) 10-90% by moles of alkyl- or phenylsilsesquioxane units, (B) an acid-generating agent capable of generating an acid by heat or light and (C) a crosslinking agent and having a characteristic to be capable of forming an antireflection film of which the optical parameter (k value, extinction coefficient) relative to ArF lasers is in the range of 0.002-0.95.

Further, the present invention provides a novel ladder-type silicone copolymer containing (hydroxyphenylalkyl)silsesquioxane units and alkylsilsesquioxane units to be used in such a composition for formation of an antireflection film.

### BRIEF DESCRIPTION OF THE DRAWING

FIG. 1 is a graph showing the relationship between the film thickness and the reflectivity in the inventive composition having an optical parameter (k value) of 0.67.

### BEST MODE FOR CARRYING OUT THE INVENTION

The composition for formation of an antireflection film of the present invention contains (A) a ladder-type silicone copolymer, (B) an acid-generating agent capable of generating an acid by heat or light and (C) a crosslinking agent as the essential ingredients.

As the ladder-type silicone copolymer as the component (A), it is necessary to use a ladder-type silicone copolymer consisting of (a₁) 10-90% by moles of (hydroxyphenylalkyl)silsesquioxane units or, namely, the constituent units represented by the general formula, 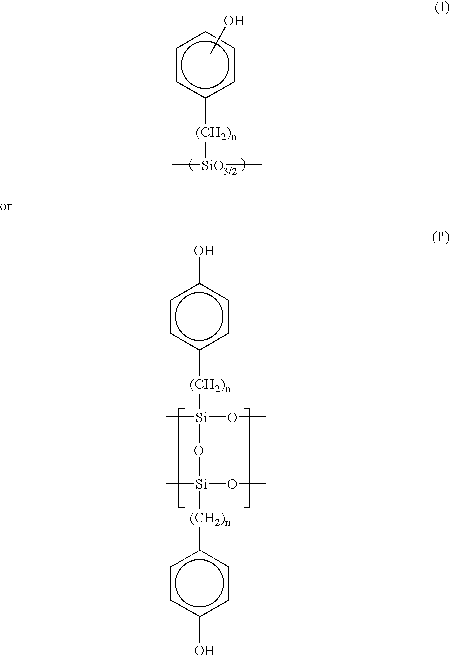
(n in the formula is a positive integer of 1-3),
(a₂) 0-50% by moles of (alkoxyphenylalkyl)silsesquioxane units or, namely, the constituent units represented by the general formula, 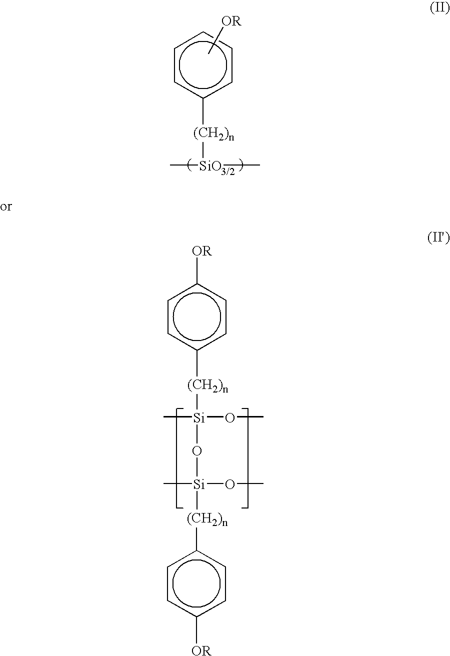
(in the formula, R is a straightly linear or branched lower alkyl group having 1-4 carbon atoms and n is a positive integer of 1-3)
and (a₃) 10-90% by moles of alkyl- or phenylsilsesquioxane units or, namely, the constituent units represented by the formula, 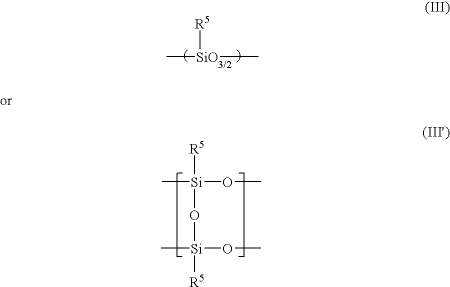
(R⁵ in the formula is a straightly linear alkyl group having 1-20 carbon atoms, a branched alkyl group having 2-20 carbon atoms or an alicyclic, a cyclic or a polycyclic alkyl group having 5-20 carbon atoms or a phenyl group). As to R in the above given general formula (II) or (II′), a methyl group is the most preferable. As to R⁵ in the general formula (III) or (III′), a lower alkyl group having 1-5 carbon atoms, cycloalkyl group having 5-6 carbon atoms or phenyl group is preferable in respect of easy adjustment of the optical parameter (k value). Further, the —OH group and —OR group in the above given general formulas (I) and (II) can be bonded to any positions of o-position, m-position and p-position of which bonding to the p-position is industrially preferable. Furthermore, (a₁), (a₂) and (a₃) units can be usually expressed by the above given general formulas (I), (II) and (III) or can be expressed by (I′), (II′) and (III′), respectively.

Preferable ladder-type silicone copolymers are those having a mass-average molecular weight (making reference to polystyrenes) in the range of 1500-30000 of which those in the range of 3000-20000 are the most preferable. The molecular weight dispersion is preferably in the range of 1.0-5.0 of which the range of 1.2-3.0 is the most preferable.

The acid-generating agent capable of generating an acid by heat or light as the component (B), which is a substance conventionally used as an ingredient in chemical-amplification type resist compositions, can be used in the present invention by appropriately selecting from those, while an onium salt or a diazomethane compound is particularly preferable.

Such an acid-generating agent is exemplified by onium salts such as diphenyliodonium trifluoromethanesulfonate or nonafluorobu-tanesulfonate, bis(4-tert-butylphenyl)iodonium trifluoromethanesulfonate or nonafluorobutanesulfonate, triphenylsulfonium trifluoromethanesulfonate or nonafluorobutanesulfonate, tri(4-methylphenyl)sulfonium trifluoromethanesulfonate or nonafluorobutanesulfonate and the like, diazomethane compounds such as bis(p-toluenesulfonyl)diazomethane, bis(1,1-dimethylethylsulfonyl)diazomethane, bis(isopropylsulfonyl)diazomethane, bis(cyclohexylsulfonyl)diazomethane, bis(2,4-dimethylphenylsulfonyl)diazomethane and the like. Particularly preferable among them are onium salts having a decomposition point of 25° C. or lower such as, for example, triphenylsulfonium trifluoromethanesulfonate, triphenylsulfonium nonafluorobutanesulfonate, 7,7-dimethyl-bicyclo-[2,2,1]-heptan-2-on-1-sulfonate of bis(p-tert-butylphenyl)iodonium and the like.

These acid-generating agents as the component (B) can be used singly or can be used as a combination of two kinds or more. The compounding amount is selected in the range of, usually, 0.5-20 parts by mass or, preferably, 1-10 parts by mass per 100 parts by mass of the above-mentioned component (A). When the amount of this acid-generating agent is smaller than 0.5 part by mass, the antireflection film formation can hardly be accomplished while, when in excess over 20 parts by mass, difficulties are encountered in obtaining a uniform solution which suffers a decrease in the storage stability.

And, the crosslinking agent as the component (C) is not particularly limited provided that an appropriate coating film can be formed as a hard-mask material capable of crosslinking the component (A) in heating or firing the inventive composition but preferable are acrylic acid esters or methacrylic acid esters of a compound having two or more reactive groups such as, for example, divinylbenzene, divinyl sulfone, triacryl formal and glyoxal and polyhydric alcohols and those from melamine, urea, benzoguanamine and glycoluril in which at least two amino groups are substituted by methylol groups or lower alkoxymethyl groups. Among them, 2,4,6,8-tetra-n-butoxymethyl-bicyclo[1.0.1]-2,4,6,8-tetraazaoctan-3,7-dione represented by the formula 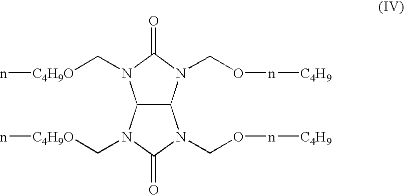
and hexamethoxymethylmelamine represented by the formula 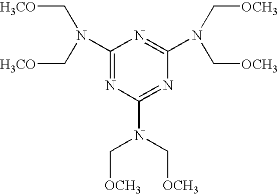
are particularly preferable.

These crosslinking agents should be used within a range of 1-10 parts by mass per 100 parts by mass of the component (A).

The composition for formation of an antireflection film of the present invention is a solution obtained by dissolving, in an organic solvent, the component (A), component (B) and component (C) mentioned above and the organic solvent used in this case can be appropriately selected from those capable of dissolving requisite amounts of these three ingredients. Those having a boiling point of 150° C. or higher are preferable taking into account the firing condition. Ketones such as acetone, methyl ethyl ketone, cyclohexanone, methyl isoamyl ketone and the like, polyhydric alcohols and derivatives thereof such as ethyleneglycol, ethyleneglycol monoacetate, propyleneglycol, propyleneglycol monoacetate, diethyleneglycol or diethyleneglycol monoacetate as well as monomethyl ethers, monoethyl ethers, monopropyl ethers, monobutyl ethers or monophenyl ethers thereof and the like, cyclic ethers such as dioxane and esters such as methyl lactate, ethyl lactate, methyl acetate, ethyl acetate, butyl acetate, methyl pyruvate, ethyl pyruvate and the like can be employed as the solvent. These can be used singly or can be used as a mixture of two kinds or more.

The organic solvent is used in a proportion of the amount of 1-20 times or, preferably, the amount of 2-10 times based on the overall mass of the solid matter.

It is essential that the composition for formation of an antireflection film of the present invention is adjusted in such a way that the antireflection film as formed has the optical parameter (k value) relative to ArF lasers or, namely, light having a wavelength of 193 nm in the range of 0.002-0.95 or, preferably, 0.1-0.7 or, more preferably, 0.15-0.4. This adjustment can be undertaken by, for example, controlling the compounding proportion of the (a₂) units in the component (A). By making adjustment to fall within such a range, a low reflectivity with stability can be exhibited by an antireflection film formed to have a thickness of 40-200 nm.

In the next place, the composition for formation of an antireflection film of the present invention can be admixed according to need further with a linear polymer as the component (D) in addition to the component (A), component (B) and component (C) mentioned above.

And, the linear polymer used as the component (D) in the inventive composition is preferably a polymer containing hydroxyl group-containing (meth)acrylic acid ester units as the constituent units such as, for example, a homopolymer of hydroxyl group-containing (meth)acrylic acid ester or a copolymer of hydroxyl group-containing (meth)acrylic acid ester and one other copolymerizable monomer.

Thus, when a polymer containing hydroxyl groups is used as the component (D) in this way, an advantage is exhibited that the hydroxyl groups act as a crosslinking agent to promote molecular weight increase so that a great improvement is accomplished in the stability against the resist solvents and developer solutions. This advantage is particularly more remarkable when a hydroxyl group-containing (meth)acrylic acid ester having an aliphatic polycyclic group like an adamantly group is used as the pendant group.

When this linear polymer is a copolymer of a hydroxyl group-containing (meth)acrylic acid ester, monomer ingredients to be copolymerized with the hydroxyl group-containing (meth)acrylic acid ester are not particularly limitative and employed by freely selecting from known monomers conventionally used for ArF resists.

Particularly satisfactory ones among the above-mentioned linear polymers containing hydroxyl group-containing (meth)acrylic acid ester units include linear copolymers consisting of (d₁) 10-60% by moles or, preferably, 20-40% by moles of the constituent units represented by the general formula 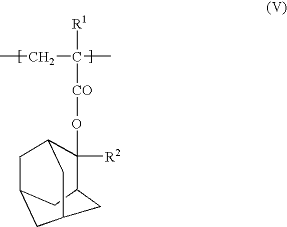
(In the formula, R¹ is a hydrogen atom or a methyl group and R² is a lower alkyl group),
(d₂) 30-80% by moles or, preferably, 20-50% by moles of the constituent units represented by the general formula 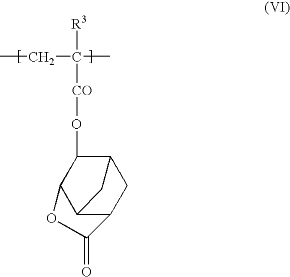
(R³ in the formula is a hydrogen atom or a methyl group)
and (d₃) 10-50% by moles or, preferably, 20-40% by moles of the constituent units represented by the general formula 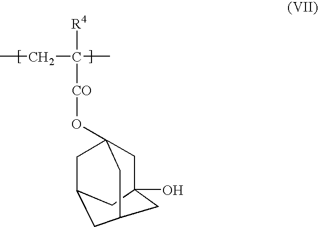
(R⁴ in the formula is a hydrogen atom or a methyl group).

As R² in the above given general formula (V), a lower alkyl group having 1-5 carbon atoms or, particularly, a methyl group or an ethyl group is preferred from the industrial viewpoint.

The linear polymer as the component (D) is preferably that having the mass-average molecular weight of 5000-20000.

The component (D) is compounded in a proportion of 10-100 parts by mass per 100 parts by mass of the component (A).

In the next place, the composition for formation of an antireflection film of the present invention can be admixed further with conventional ionic or non-ionic surface active agents in order to ensure the dispersive power and uniformity of the coating film, in addition to the above-mentioned component (A), component (B) and component (C) as well as component (D) compounded according to the case.

These surface active agents are added in a proportion of 0.05-1.0 part by mass per 100 parts by mass of the total amount of the solid matter.

The composition for formation of an antireflection film of the present invention can be easily applied onto a substrate such as a silicon wafer by using the conventional spin-coating method and it is possible to form an antireflection film having a desired thickness. The procedure turns out to be convenient, by taking into account the fact that it is necessary in the conventional lithographic process to form an oxidized film on a substrate by deposition and to apply a resist film thereon.

Formation of this antireflection film is conducted preferably by the multiple-stage heating method in which spin coating of a substrate and drying are followed by heating at or below the boiling point of the solvent or, for example, at 100-120° C. for 60-120 seconds and then at 200-250° C. for 60-120 seconds. An antireflection film having a thickness of 40-200 nm is formed in this way followed by providing thereon a resist film having a thickness of 100-300 nm to prepare a resist material. It is possible in this case to obtain a three-layered resist material by first providing an organic layer having a thickness of 200-600 nm on a substrate and then forming the above-mentioned antireflection film as an intermediate layer between the organic layer and the resist film.

A ladder-type silicone copolymer as the component (A) used in such a composition for formation of an antireflection film is important as a base resinous ingredient for a composition for formation of an antireflection film or, particularly, as an ingredient when the optical parameter (k value) of the said composition relative to ArF lasers or, namely, light having a wavelength of 193 nm is adjusted to be 0.002-0.95 and such an adjustment can be efficiently undertaken. Furthermore, the said copolymer is preferable in respect of high silicon content and high O₂ plasma resistance.

The said ladder-type silicone copolymer can be synthesized according to a method known per se such as, for example, the method of Preparation Example 1 described in official publication of Japanese Patent No. 2567984.

Among the ladder-type silicone copolymers as the component (A), copolymers containing a combination of (hydroxyphenylalkyl)silsesquioxane units and alkylsilsesquioxane units are novel compounds not described in any literatures. For use in the composition for formation of an antireflection film of the present invention, the compounding proportion of the (hydroxyphenylalkyl)silsesquioxane units and the alkylsilsesquioxane units is preferably in the range from 10:90 to 90:10 in a molar ratio of which those having a mass-average molecular weight of 1500-30000 or, particularly, 3000-20000 with a molecular weight dispersion in the range of 1.0-5.0 or, particularly, 1.2-3.0 are more preferable.

According to the present invention, a composition for formation of an antireflection film which is suitable for coating with easiness by a conventional spin-coating method using a resist coater, capable of giving a mask pattern having good storage stability and resistance against oxygen plasma etching and an excellent cross sectional profile and suitable for ready introduction of chromophores for absorption of radiations and adjustment of the reflection-preventing power due to a solution prepared by dissolving in an organic solvent with good dispersion as well as a ladder-type silicone copolymer used therein are provided.

In the following, the best mode for carrying out the present invention is described in more details by way of examples although the present invention is never limited by these examples in any way.

The compounds showing below were used as the acid-generating agents as the component (B), the crosslinking agents as the component (C) and the linear polymers as the component (D) in the respective Examples.

(1) Acid-Generating Agent:

Component (B) 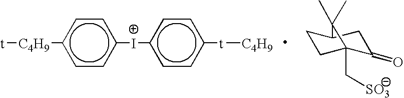
(2) Crosslinking Agent:
Component (C₁) 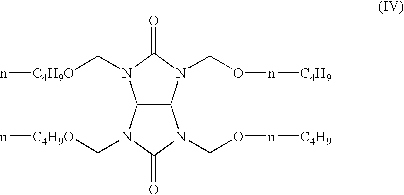
or
Component (C₂) 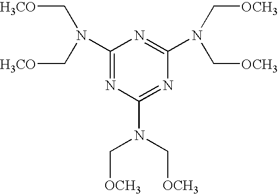
(3) Linear Polymer:
Component (D)

Acrylate-type polymer containing 30% by moles of 2-ethyl-2-adamantyl acrylate units, 40% by moles of units of the general formula (V), R₃ being a hydrogen atom, and 30% by moles of 3-hydroxy1-adamantyl acrylate units

Mass-average molecular weight 10000

The optical parameters (k value: extinction coefficient) in the respective Examples are the values measured by the following methods.

Namely, the sample was applied onto an 8-inch silicon wafer to form a coating film having a film thickness of 50 nm, measurement was made by a spectroscopic ellipsometry (J.A. Woolam Co., “VUV-VASE”) and analysis was made by an analytical software (WVASE32) manufactured by the same company.

### REFERENCE EXAMPLE 1

Into a 500 ml three-necked flask equipped with a stirrer, reflux condenser, dropping funnel and thermometer were introduced 1.00 mole (84.0 g) of sodium hydrogencarbonate and 400 ml of water and then a solution obtained by dissolving 0.36 mole (92.0 g) of p-methoxybenzyl trichlorosilane and 0.14 mole (29.6 g) of phenyl trichlorosilane in 100 ml of diethyl ether was added dropwise through the dropping funnel under agitation over 2 hours followed by heating for 1 hour under reflux. After completion of the reaction, the reaction product was extracted from the reaction mixture with diethyl ether and the extract solution was freed from diethyl ether by distillation under reduced pressure to collect a hydrolysis product.

The thus obtained hydrolysis product was admixed with 0.33 g of a 10% by mass aqueous solution of potassium hydroxide and heated for 2 hours at 200° C. to prepare a copolymer A₁ (64.4 g) consisting of 72% by moles of p-methoxybenzyl silsesquioxane units and 28% by moles of phenyl silsesquioxane units. The analytical results of the copolymer A₁ by the proton NMR, infrared absorption spectrum and GPC (gel permeation chromatography) are shown below.

¹H-NMR (DMSO-d₆): δ=2.70 ppm (—CH₂—); 3.50 ppm (—OCH₃); and 6.00-7.50 ppm (benzene ring);

IR (cm⁻¹): ν=1178 (—OCH₃); and 1244 and 1039 (—SiO—);

Mass-average molecular weight (Mw): 7500; and dispersion (Mw/Mn):1.8

In the next place, this copolymer A₁ was added to a solution prepared by dissolving 150 ml of acetonitrile together with 0.4 mole (80.0 g) of trimethylsillyl iodide and agitated for 24 hours under reflux and then 50 ml of water were added thereto followed by agitation for further 12 hours under reflux to effect the reaction. After cooling, reduction of free iodine was undertaken with an aqueous solution of sodium hydrogensulfite followed by separation of the organic layer which was freed from the solvent by distillation. The residue was subjected to reprecipitation with acetone and n-hexane followed by drying by heating under reduced pressure to prepare a copolymer A₂ (39.0 g) consisting of 72% by moles of (p-hydroxybenzyl)silsesquioxane units and 28% by moles of phenyl silsesquioxane units. The analytical results of the copolymer A₂ by the proton NMR, infrared absorption spectrum and GPC (gel permeation chromatography) are shown below.

¹H-NMR (DMSO-d₆): δ=2.70 ppm (—CH₂—); 6.00-7.50 ppm (benzene ring); and 8.90 ppm (—OH);

IR (cm⁻¹): ν=3300 (—OH); and 1244 and 1047 (—SiO—);

Mass-average molecular weight (Mw): 7000; and dispersion (Mw/Mn):1.8

### REFERENCE EXAMPLE 2

The copolymer A₁ prepared in Reference Example 1 was added to a solution prepared by dissolving 150 ml of acetonitrile together with 0.250 mole (50.0 g) of trimethylsillyl iodide and agitated for 24 hours under reflux and then 50 ml of water were added thereto followed by agitation for further 12 hours under reflux to effect the reaction. After cooling, reduction of free iodine was undertaken with an aqueous solution of sodium hydrogensulfite followed by separation of the organic layer which was freed from the solvent by distillation. The residue was subjected to reprecipitation with acetone and n-hexane followed by drying by heating under reduced pressure to prepare a copolymer A₃ (40.3 g) consisting of 36% by moles of (p-hydroxybenzyl)silsesquioxane units, 36% by moles of p-methoxybenzyl silsesquioxane units and 28% by moles of phenyl silsesquioxane units. The analytical results of the copolymer A₂ by the proton NMR, infrared absorption spectrum and GPC (gel permeation chromatography) are shown below.

¹H-NMR (DMSO-d₆): δ=2.70 ppm (—CH₂—); 3.50 ppm (—OCH₃), 6.00-7.50 ppm (benzene ring); and 8.90 ppm (—OH);

IR (cm⁻¹): ν=3300 (—OH); 1178 (—OCH₃); and 1244 and 1047 (—SiO—);

Mass-average molecular weight (Mw): 7000; and dispersion (Mw/Mn): 1.8

### REFERENCE EXAMPLE 3

The copolymer A₁ prepared in Reference Example 1 was added to a solution prepared by dissolving 150 ml of acetonitrile together with 0.347 mole (69.4 g) of trimethylsillyl iodide and agitated for 24 hours under reflux and then 50 ml of water were added thereto followed by agitation for further 12 hours under reflux to effect the reaction. After cooling, reduction of free iodine was undertaken with an aqueous solution of sodium hydrogensulfite followed by separation of the organic layer which was freed from the solvent by distillation. The residue was subjected to reprecipitation with acetone and n-hexane followed by drying by heating under reduced pressure to prepare a copolymer A₄ (39.8 g) consisting of 50% by moles of (p-hydroxybenzyl)silsesquioxane units, 22% by moles of p-methoxybenzyl silsesquioxane units and 28% by moles of phenyl silsesquioxane units. The analytical results of the copolymer A₄ by the proton NMR, infrared absorption spectrum and GPC (gel permeation chromatography) are shown below.

¹H-NMR (DMSO-d₆): δ=2.70 ppm (—CH₂—); 3.50 ppm (—OCH₃), 6.00-7.50 ppm (benzene ring); and 8.90 ppm (—OH);

IR (cm^{31 1}): ν=3300 (—OH); 1178 (—OCH₃); and 1244 and 1047 (—SiO—);

Mass-average molecular weight (Mw): 7000; and dispersion (Mw/Mn):1.8

### EXAMPLE 1

Into a 500 ml three-necked flask equipped with a stirrer, reflux condenser, dropping funnel and thermometer were introduced 1.00 mole (84.0 g) of sodium hydrogencarbonate and 400 ml of water and then a solution obtained by dissolving 0.36 mole (92.0 g) of p-methoxybenzyl trichlorosilane and 0.14 mole (24.9 g) of n-propyl trichlorosilane in 100 ml of diethyl ether was added dropwise through the dropping funnel under agitation over 2 hours followed by heating for 1 hour under reflux. After completion of the reaction, the reaction product was extracted with diethyl ether and the extract solution was freed from diethyl ether by distillation under reduced pressure.

The thus obtained hydrolysis product was admixed with 0.33 g of a 10% by mass aqueous solution of potassium hydroxide and heated for 2 hours at 200° C. to prepare a copolymer A₅ (60.6 g) consisting of 72% by moles of p-methoxybenzyl silsesquioxane units and 28% by moles of n-propyl silsesquioxane units. The analytical results of the copolymer A₅ by the proton NMR, infrared absorption spectrum and GPC (gel permeation chromatography) are shown below.

¹H-NMR (DMSO-d₆): δ=1.00-2.00 ppm (-n-propyl); 2.70 ppm (—CH₂—); 3.50 ppm (—OCH₃); and 6.00-7.50 ppm (benzene ring);

IR (cm⁻¹): ν=1178 (—OCH₃); and 1244 and 1039 (—SiO—);

Mass-average molecular weight (Mw): 7500; and dispersion (Mw/Mn):1.8

In the next place, this copolymer A₅ was added to a solution prepared by dissolving 150 ml of acetonitrile together with 0.4 mole (80.0 g) of trimethylsillyl iodide and agitated for 24 hours under reflux and then 50 ml of water were added thereto followed by agitation for further 12 hours under reflux to effect the reaction. After cooling, reduction of free iodine was undertaken with an aqueous solution of sodium hydrogensulfite followed by separation of the organic layer which was freed from the solvent by distillation. The residue was subjected to reprecipitation with acetone and n-hexane followed by drying by heating under reduced pressure to prepare a copolymer A₆ (36.6 g) consisting of 72% by moles of (p-hydroxybenzyl)silsesquioxane units and 28% by moles of n-propyl silsesquioxane units. The analytical results of the copolymer A₆ by the proton NMR, infrared absorption spectrum and GPC (gel permeation chromatography) are shown below.

¹H-NMR (DMSO-d₆): δ=1.00-2.00 ppm (-n-propyl); 2.70 ppm (—CH₂—); 6.00-7.50 ppm (benzene ring); and 8.90 ppm (—OH);

IR (cm⁻¹): ν=3300 (—OH); and 1244 and 1047 (—SiO—);

Mass-average molecular weight (Mw): 7000; and dispersion (Mw/Mn):1.8

### REFERENCE EXAMPLE 4

Into a 500 ml three-necked flask equipped with a stirrer, reflux condenser, dropping funnel and thermometer were introduced 1.00 mole (84.0 g) of sodium hydrogencarbonate and 400 ml of water and then a solution obtained by dissolving 0.32 mole (81.8 g) of p-methoxybenzyl trichlorosilane and 0.18 mole (38.1 g) of phenyl trichlorosilane in 100 ml of diethyl ether was added dropwise through the dropping funnel under agitation over 2 hours followed by heating for 1 hour under reflux. After completion of the reaction, the reaction product was extracted with diethyl ether and the extract solution was freed from diethyl ether by distillation under reduced pressure.

The thus obtained hydrolysis product was admixed with 0.33 g of a 10% by mass aqueous solution of potassium hydroxide and heated for 2 hours at 200° C. to prepare a copolymer A₇ (62.9 g) consisting of 64% by moles of p-methoxybenzyl silsesquioxane units and 36% by moles of phenyl silsesquioxane units. The analytical results of the copolymer A₇ by the proton NMR, infrared absorption spectrum and GPC (gel permeation chromatography) are shown below.

¹H-NMR (DMSO-d₆): δ=2.70 ppm (—CH₂—); 3.50 ppm (—OCH₃); and 6.00-7.50 ppm (benzene ring);

IR (cm⁻¹): ν=1178 (—OCH₃); and 1244 and 1039 (—SiO—);

Mass-average molecular weight (Mw): 7500; and dispersion (Mw/Mn):1.8

In the next place, this copolymer A₇ was added to a solution prepared by dissolving 150 ml of acetonitrile together with 0.4 mole (80.0 g) of trimethylsillyl iodide and agitated for 24 hours under reflux and then 50 ml of water were added thereto followed by agitation for further 12 hours under reflux to effect the reaction. After cooling, reduction of free iodine was undertaken with an aqueous solution of sodium hydrogensulfite followed by separation of the organic layer which was freed from the solvent by distillation. The residue was subjected to reprecipitation with acetone and n-hexane followed by drying by heating under reduced pressure to prepare a copolymer A₈ (38.4 g) consisting of 64% by moles of (p-hydroxybenzyl)silsesquioxane units and 36% by moles of phenyl silsesquioxane units. The analytical results of the copolymer A₈ by the proton NMR, infrared absorption spectrum and GPC (gel permeation chromatography) are shown below.

¹H-NMR (DMSO-d₆): δ=2.70 ppm (—CH₂—); 6.00-7.50 ppm (benzene ring); and 8.90 ppm (—OH);

IR (cm⁻¹): ν=3300 (—OH); and 1244 and 1047 (—SiO—);

Mass-average molecular weight (Mw): 7000; and dispersion (Mw/Mn): 1.8

### EXAMPLE 2

A composition for formation of an antireflection film was prepared by using the copolymer A₂ (mass-average molecular weight of 7000) in Reference Example 1 consisting of 72% by moles of (p-hydroxybenzyl)silsesquioxane units and 28% by moles of phenyl silsesquioxane units as a ladder-type silicone copolymer or, namely, component (A) and by dissolving, in 300 parts by mass of propyleneglycol monopropyl ether, a mixture obtained by adding 83 parts by mass of this component (A), 3 parts by mass of the above-mentioned component (B) as the acid-generating agent and 5 parts by mass of the component (C₁) as the crosslinking agent together with 17 parts by mass of the above-mentioned acrylate-type polymer as the component (D).

In the next place, the above-mentioned composition was applied onto a silicon wafer by using a conventional resist coater followed by two-step heating treatment under conditions at 100° C. for 90 seconds and then at 250° C. for 90 seconds to form an antireflection film having a thickness of 55 nm.

The optical parameter (k value) of this antireflection film was 0.67.

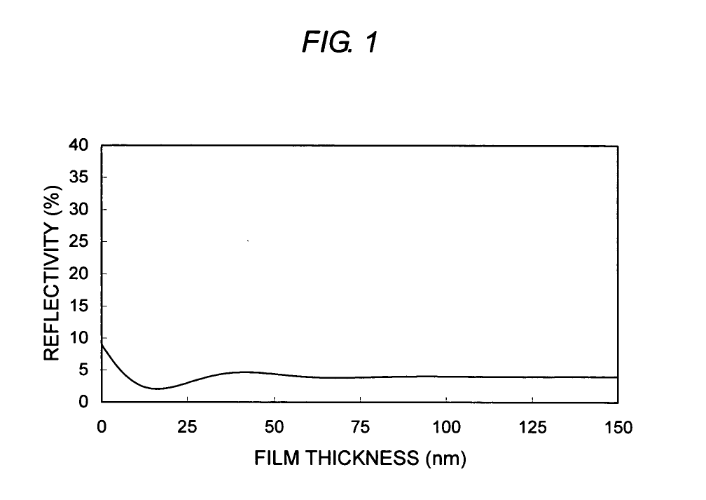

Coating films having different thicknesses were formed in this way to measure reflectivities relative to their thicknesses which are shown as a graph in FIG. 1.

As is understood from this figure, a low reflectivity with stability is exhibited with a thickness of the film used in the range of 40-150 nm assuming a k value of 0.67.

### EXAMPLE 3

A composition for formation of an antireflection film was prepared by using the copolymer A₃ (mass-average molecular weight of 7000) in Reference Example 2 consisting of 36% by moles of (p-hydroxybenzyl)silsesquioxane units, 36% by moles of p-methoxybenzyl silsesquioxane units and 28% by moles of phenyl silsesquioxane units as the component (A) and by dissolving, in 300 parts by mass of a mixture of propyleneglycol monomethyl ether monoacetate and propyleneglycol monomethyl ether (mass proportion of 40/60), 100 parts by mass of this component (A), 3 parts by mass of the above-mentioned component (B) as the acid-generating agent and 5 parts by mass of the above-mentioned component (C₁) as the crosslinking agent.

The above-mentioned composition was applied onto a silicon wafer by using a conventional resist coater followed by conducting two-step heating treatment under conditions at 100° C. for 90 seconds and then at 250° C. for 90 seconds to form an antireflection film having a thickness of 50 nm.

The optical parameter (k value) of this antireflection film was 0.67.

### EXAMPLE 4

A composition for formation of an antireflection film was prepared by using the copolymer A₄ (mass-average molecular weight of 7000) in Reference Example 3 consisting of 50% by moles of (p-hydroxybenzyl)silsesquioxane units, 22% by moles of p-methoxybenzyl silsesquioxane units and 28% by moles of phenyl silsesquioxane units as the component (A) and by dissolving, in 300 parts by mass of propyleneglycol monomethyl ether monoacetate, 100 parts by mass of this component (A), 3 parts by mass of the above-mentioned component (B) as the acid-generating agent and 5 parts by mass of the above-mentioned component (C₁) as the crosslinking agent.

This composition was applied onto a silicon wafer in the same manner as in Example 2 followed by heating at 100° C. for 90 seconds and then heating at 230° C. for 90 seconds to form an antireflection film having a thickness of 70 nm. The optical parameter (k value) of this antireflection film was 0.90.

### EXAMPLE 5

An antireflection film having a thickness of 70 nm was formed in the same manner as in Example 4 except that the two-step heating treatment was replaced with a single-step heating treatment at 250° C. for 90 seconds.

The optical parameter (k value) of this antireflection film was 0.90.

### EXAMPLE 6

A composition for formation of an antireflection film was prepared by using the copolymer A₆ (mass-average molecular weight of 7000) in Example 1 consisting of 72% by moles of (p-hydroxybenzyl)silsesquioxane units and 28% by moles of n-propyl silsesquioxane units as the component (A) and by dissolving, in 300 parts by mass of propyleneglycol monopropyl ether, a mixture obtained by adding 83 parts by mass of this component (A), 3 parts by mass of the above-mentioned component (B) as the acid-generating agent and 5 parts by mass of the above-mentioned component (C₁) as the crosslinking agent together with 17 parts by mass of the above-mentioned component (D) as the linear polymer. In the next place, the above-mentioned composition was applied onto a silicon wafer by using a conventional resist coater followed by conducting two-step heating treatment under conditions at 100° C. for 90 seconds and then at 250° C. for 90 seconds to form an antireflection film having a thickness of 55 nm.

The optical parameter (k value) of this antireflection film was 0.55.

### EXAMPLE 7

A composition for formation of an antireflection film was prepared by using the copolymer A₈ (mass-average molecular weight of 7000) in Reference Example 4 consisting of 64% by moles of (p-hydroxybenzyl)silsesquioxane units and 36% by moles of phenyl silsesquioxane units as the component (A) and by dissolving, in 300 parts by mass of propyleneglycol monopropyl ether, a mixture obtained by adding 83 parts by mass of this component (A), 3 parts by mass of the above-mentioned component (B) as the acid-generating agent and 5 parts by mass of the above-mentioned component (C₂) as the crosslinking agent together with 17 parts by mass of the above-mentioned component (D) as the linear polymer. In the next place, the above-mentioned composition was applied onto a silicon wafer by using a conventional resist coater followed by conducting two-step heating treatment under conditions at 100° C. for 90 seconds and then at 250° C. for 90 seconds to form an antireflection film having a thickness of 75 nm.

The optical parameter (k value) of this antireflection film was 0.49.

### COMPARATIVE EXAMPLE

By using a commercially available coating solution which was mainly a mixture of a cohydrolyzate and a condensate of tetraalkoxysilane and methyltrialkoxysilane (a product by Tokyo Ohka Kogyo Co., product name “OCD T-7ML02”) as a composition for formation of an antireflection film, the same was applied onto a silicon wafer with a coater for exclusive use on SOG followed by a three-step heating treatment under conditions first at 80° C. for 90 seconds, then at 150° C. for 90 seconds and finally at 250° C. for 90 seconds to form an antireflection film of 50 nm thickness.

As the aforementioned coating solution became dried, there was instantaneously formed a powdery precipitate which acted as a contaminant on the coater nozzle, coater cup, wafers and others so that no coating could be conducted with conventional resist coaters.

### APPLICATION EXAMPLE

Each of the compositions for formation of an antireflection film in the respective Examples and Comparative Example mentioned above was subjected to the tests for the storage stability, coating adaptability with the a resist coater and resistance against oxygen plasma etching by the following methods and the results are shown in Table 1.

(1) Storage Stability (Variations in Film Thickness):

Test samples were prepared by keeping specified compositions at room temperature (20° C.) or as frozen (−20° C.) for 45 days and they were each applied by spin-coating onto an 8-inch silicon wafer under identical coating conditions followed by drying to form a coating film. The film thickness was respectively determined and evaluation was made as G when the difference in the film thickness from the room temperature-stored sample was 5% or smalle and as NG when the difference was larger as compared with the film thickness from the freeze-stored sample.

(2) Storage Stability (Occurrence of Particles):

The sample after storage at a room temperature in (1) was subjected to measurement for occurrence of particles having a particle diameter of 0.22 μm or larger by a particle counter (manufactured by Rion Co., product name of “Particle Sensor KS-41”) to give G to the case of 300 particles or less and NG to the case in excess thereof.

(3) Coating Adaptability with Resist Coater:

Absense of particles is essential in the edge rinse step and the auto-dispensing step for adaptability to coating with a resist coater. Accordingly, the sample was dissolved in propyleneglycol methyl ether acetate, propylene glycol monomethyl ether or ethyl lactate followed by observation of occurrence of particles and evaluated to give G to the case of absence and NG to the case of presence thereof.

(4) Resistance Against Oxygen Plasma Etching (Etching Rate):

The samples were subjected to etching under the following conditions to determine the etching rate thereof. As this value was small, the resistance against oxygen plasma etching was excellent.

Etching device: GP-12 (manufactured by Tokyo Ohka Kogyo Co., oxygen plasma etching device)

Etching gas: O₂/N₂ (60/40 sccm)

Pressure: 0.4 Pa

Output power: 1600 W

Bias power: 150 W

Stage temperature: −10° C.

TABLE 1

| | | Properties | | | |
|---|---|---|---|---|---|
| | | | | | Resistance |
| | | Storage stability | | | against |
| | | Variations in | Occurrence | Resist | oxygen plasma |
| Examples | | film thickness | of particles | coater | etching (nm/s) |
| Examples | 2 | G | G | G | 0.15 |
| | 3 | G | G | G | 0.15 |
| | 4 | G | G | G | 0.15 |
| | 5 | G | G | G | 0.15 |
| | 6 | G | G | G | 0.14 |
| | 7 | G | G | G | 0.13 |

| | | | | |
|---|---|---|---|---|
| Comparative | NG | NG | NG | 0.063 |
| Example | | | | |

### INDUSTRIAL UTILIZABILITY

The composition for formation of an antireflection film of the present invention has excellent storage stability, is suitable for adjustment of the reflection-preventing power by introducing chromophores capable of absorbing radiations and is suitable for coating with easiness by the conventional spin-coating method due to solubility in organic solvents and accordingly is satisfactorily used in the manufacture of semiconductor devices.

1. A composition for formation of an antireflection film prepared by dissolving, in an organic solvent, (A) a ladder-type silicone copolymer consisting of (a₁) 10-90% by moles of (hydroxyphenylalkyl)silsesquioxane units, (a₂) 0-50% by moles of (alkoxyphenylalkyl)silsesquioxane units and (a₃) 10-90% by moles of alkyl- or phenylsilsesquioxane units, (B) an acid-generating agent capable of generating an acid by heat or light and (C) a crosslinking agent and having a characteristic to be capable of forming an antireflection film of which the optical parameter (k value) relative to ArF lasers is in the range of 0.002-0.95.

2. The composition for formation of an antireflection film described in claim 1 which further contains (D) a linear polymer in addition to the component (A), component (B) and component (C).

3. The composition for formation of an antireflection film described in claim 2 in which the said (D) linear polymer is a polymer containing hydroxyl group-containing (meth)acrylic acid ester units.

4. The composition for formation of an antireflection film described in claim 3 in which the said (D) linear polymer is a polymer containing (meth)acrylic acid ester units having hydroxyl group-containing aliphatic polycyclic groups.

5. The composition for formation of an antireflection film described in claim 3 in which the said (D) linear polymer is a linear copolymer consisting of 10-60% by moles of the constituent units (d₁) represented by the general formula, 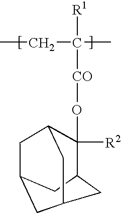
(In the formula, R¹ is a hydrogen atom or a methyl group and R² is an alkyl group),
30-80% by moles of the constituent units (d₂) represented by the general formula, 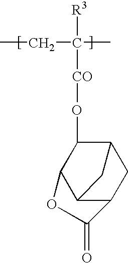
(R³ in the formula is a hydrogen atom or a methyl group) and
10-50% by moles of the constituent units (d₃) represented by the general formula, 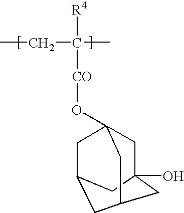
(R⁴ in the formula is a hydrogen atom or a methyl group).

6. A ladder-type silicone copolymer which contains (hydroxyphenylalkyl)silsesquioxane units and alkylsilsesquioxane units.

7. The ladder-type silicone copolymer described in claim 6 in which the compounding proportion of the (hydroxyphenylalkyl)silsesquioxane units and the alkylsilsesquioxane units is from 10:90 to 90:10 in the molar ratio.

8. The ladder-type silicone copolymer described in claim 6 of which the mass-average molecular weight is 1500-30000.

9. The ladder-type silicone copolymer described in claim 6 of which the molecular weight dispersion is in the range of 1.0-5.0.
